(19) United States
(12) Patent Application Publication
(10) Pub. No.: US 2025/0306582 A1
(43) Pub. Date: Oct. 2, 2025

(54) DYNAMICALLY SILENCING ALERTS DURING MAINTENANCE OPERATIONS

(71) Applicant: INTERNATIONAL BUSINESS MACHINES CORPORATION, ARMONK, NY (US)

(72) Inventors: Michele Crudele, Rome (IT); Andrea Innocenti, Rome (IT); Luca Ioffredo, Napoli (IT)

(21) Appl. No.: 18/617,595

(22) Filed: Mar. 26, 2024

(51) Int. Cl. G05B 23/02

(52) U.S. Cl. CPC G05B 23/027; G05B 23/0283

(57) ABSTRACT

A computer-implemented method for identifying anomalies in a monitored system caused by a maintenance operation includes receiving a first quantity, indicative of an event associated with execution of the maintenance operation, and a second quantity, indicative of an anomaly associated with the monitoring system. An alert silencing score is calculated based upon the first quantity and the second quantity, where the alert silencing score is associated with a probability that the second quantity is causally related with the first quantity. The method can continuously determine, based upon the alert silencing score, whether the second quantity is causally related to the maintenance operation.

### BACKGROUND

The present disclosure generally relates to systems and methods for silencing alerts, and more particularly, to methods and systems for silencing alerts that are false positive alerts that may occur during maintenance operations.

With the high availability of tens of thousands of servers, devices, virtual machines, and components in the cloud or on-premise, real-time monitoring of these devices or cloud components is salient. Monitoring tools (e.g., sysdig, zabbix) create alerts when metrics breach a pre-specified threshold for a given amount of time, such as a server's latency is more than 1 second for the past 10 minutes. The hundreds of entities that are monitored to capture golden signals, rate-errors-duration (RED), utilization-saturation-errors (USE) signals, or other signals result in thousands of alert categories.

During maintenance operations, false positive alerts may be generated. Dealing with such false positive alerts may consume time and create alert fatigue. Such alerts can be generated, for example, when isolating regions during the update of worker nodes.

### SUMMARY

In one embodiment, a system and method are described for reducing alert noise and alert fatigue that can address the issue of false positive alerts being generated during maintenance operations.

In one embodiment, a computer implemented method and a computer program product can be configured for identifying anomalies in a monitored system caused by a maintenance operation includes receiving a first quantity, indicative of an event associated with execution of the maintenance operation, and a second quantity, indicative of an anomaly associated with the monitoring system. An alert silencing score is calculated based upon the first quantity and the second quantity, where the alert silencing score is associated with a probability that the second quantity is causally related with the first quantity. The method can continuously determine, based upon the alert silencing score, whether the second quantity is causally related to the maintenance operation.

In another embodiment, a system includes a processor; a data bus coupled to the processor; a memory coupled to the data bus; and a computer-usable medium embodying a computer program code, the computer program code comprising instructions executable by the processor. The computer program code is configured to receive a first quantity, indicative of an event associated with execution of the maintenance operation, and a second quantity, indicative of an anomaly associated with the monitoring system. An alert silencing score is calculated based upon the first quantity and the second quantity, where the alert silencing score is associated with a probability that the second quantity is causally related with the first quantity. The method can continuously determine, based upon the alert silencing score, whether the second quantity is causally related to the maintenance operation.

In one embodiment, first quantity can include a start time of the maintenance operation, an end time of the maintenance operation, and operation names for the maintenance operation. The second quantity is an alert received from an observability service.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a schematic alert flow diagram incorporating an intelligent alert filtering system, consistent with an illustrative embodiment;

FIGS. 2A and 2B show a flow chart depicting treatment of an alert, consistent with an illustrative embodiment; and

FIG. 3 is a functional block diagram illustration of a computer hardware platform that can be used to implement the method for reducing false positive alerts caused by maintenance operations, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can automatically detect an alert that has been fired by a maintenance operation and silence the alert. The system can integrate with service ops tools, such as Jenkins, Tekton, or the like, and can correlate alerts with service operations. The system can learn, over time, which operations trigger a set of alerts and propose to or automatically silence them. After a learning period, the system can identify when an anomaly is caused by a maintenance operation and classify it as such, and can update the classification of an anomaly when it discovers that a maintenance operation no longer generates a specific alert.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may learn alerts that are triggered by computer implemented maintenance operations and automatically detect and silence those alerts. This may have the technical effect of reducing alert signals and alert fatigue. Accordingly, the system and methods according to aspects of the present disclosure provide a substantial improvement to technology and computer functionality.

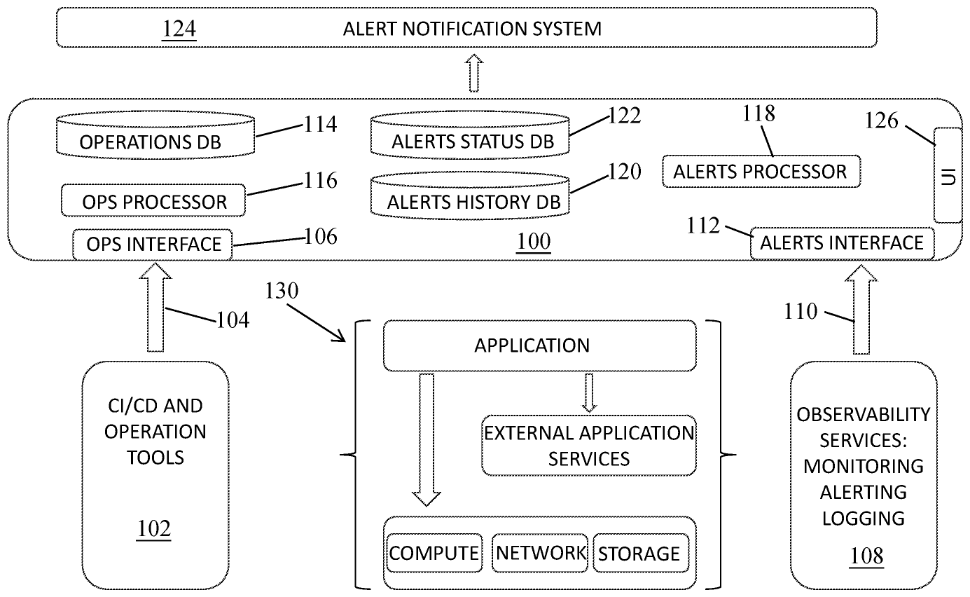

Referring to FIG. 1, an intelligent alert filtering system 100 can integrate with continuous integration and continuous deployment (CI/CD) and operation tools 102, also referred to as DevOps tools 102, to receive a signal 104, indicating a start and/or a stop of maintenance operations of a computing system 130, into an ops interface 106 of the system 100. The system 100 can further integrate with observability services 108 to receive alerts 110 into an alerts interface 112.

The system 100 can include an operations database 114 that can include each maintenance operation name, each maintenance operation's input parameters, the start time of each maintenance operation, the end time of each maintenance operation, and the status of each maintenance operation. The system 100 can further include an operations processor 116 that can write to the operations database 114 a status of IN_PROGRESS when a maintenance operation is started. The operations processor 116 can further update the operations database 114 the end time and status upon being notified of a stop event. The status can be updated as either SUCCESS or FAILED in the operations database 114.

Upon receiving an alert 110 an alerts processor 118 of the system 100 can store the alert 110 in an alerts history database 120, utilizing one row for each running operation. The alerts history database 120 can record the alert-id, operation name and input parameters, and the time the alert fired. The alerts processor 118 can check to determine if the alert 110 was silenced for the maintenance operation. An alerts status database 122 can store information for each alert, including an alert-id, an operation name and input parameters and an alert status, where the alert status can indicate if the alert is in a SILENCED state for the maintenance operation. If the alert 110 is not in the SILENCED state, the alert 110 is forwarded to an alert notification system 124.

The alerts processor 118 can check if the alert 110, when not in the SILENCED state already, should be silenced for one or more maintenance operations. If the alert 110 should be silenced, based on a determination discussed in greater detail below, then the status of the alert can be updated to CANDIDATE or SILENCED in the alert status database 122, depending on the configuration of the system 100. A CANDIDATE status alert may be sent to an administrator, via a user interface 126, for determination if such an alert may be silenced. The system 100 may be configured to automatically silence alerts depending on the configuration settings.

As discussed above, the system 100 can make a determination whether an alert 110 should be flagged to be silenced (either automatically updated to a SILENCED state or placed into a CANDIDATE state, depending on system configuration). This determination can be made by the alerts processor 118 generating an alert silencing score, which is a measure of the probability that the alert was caused by a maintenance operation. The alert silencing score can be calculated as a ratio between the number of times that the alert was fired while the operation was running (as provided by the alerts history database 120), and the total number of times that the operation ran (as provided by the operations database 114). In one embodiment, the alert silencing score threshold can be configured by an administrator via the user interface 126, for example.

In some embodiments, the alert silencing score can be calculated in other manners, such as by using machine learning techniques to take additional features into consideration, such as fired-time, operation start time, operation end time, status, and the like.

As discussed above, the system 100 can be configured to take automatic actions to silence alerts based on the alert silencing score, or can mark such alerts as CANDIDATE status, where an administrator can make a final determination to silence the alert during a maintenance operation.

### Example Process

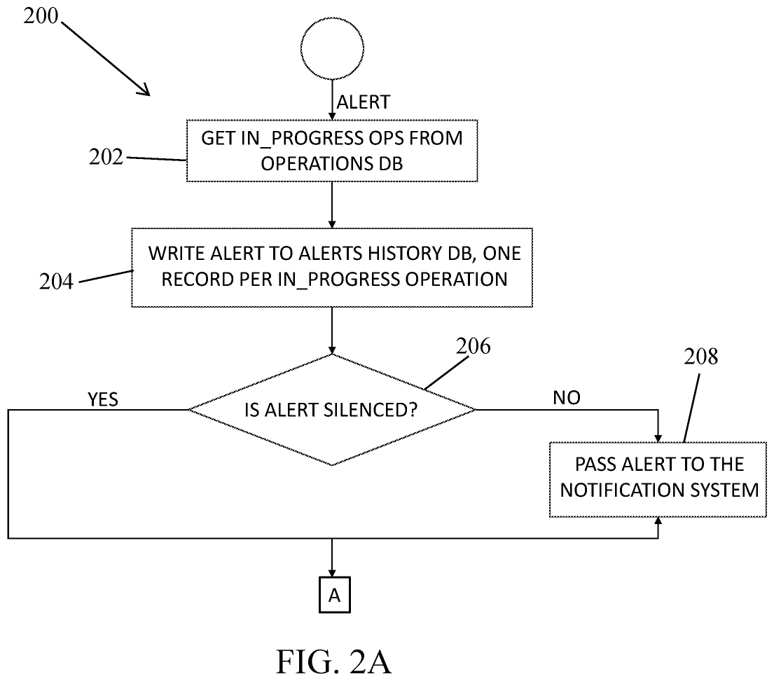

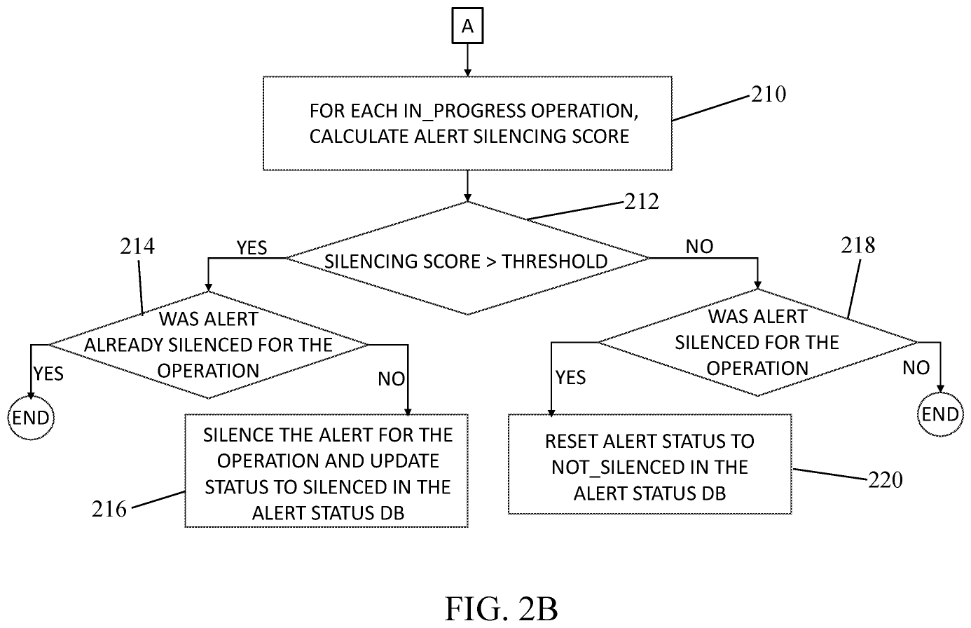

It may be helpful now to consider a high-level discussion of an example process. To that end, FIGS. 2A and 2B presents an illustrative process related to the method for analyzing and silencing alerts. Process 200 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIGS. 2A and 2B, block 202 of process 200, can include an act of receiving an alert and retrieving IN_PROCESS operations from the operations database. At block 204, the alert can be written to the alert history database, writing one record per each IN_PROCESS operation. At block 206, the alerts processor can determine if the alert is silenced. If not, the alert is passed to the alert notification system at block 208.

For each IN_PROGRESS operation, an alert silencing score can be determined at block 210. As described above, the alert silencing score can determine the probability that the alert was caused by the maintenance operation. At block 212, it can be determined whether the silencing score is greater than a predetermined threshold. If the alert silencing score is greater than the predetermined threshold, and if the alert was already silenced for the maintenance operation, as determined at block 214, then the process ends. If the alert silencing score is greater than the predetermined threshold, and if the alert was not already silenced for the maintenance operation, then, at block 216, the alert is silenced and the status of the alert is updated to SILENCED in the alert status database. If the alert silencing score is not greater than the predetermined threshold, as determined at block 218, and if the alert was not already silenced, then the process ends. If the alert silencing score is not greater than the predetermined threshold, and if the alert was already silenced, then, at block 220, the alert status is reset to NOT_SILENCED in the alert status database and the alert is sent to the alert notification system. Various systems may be monitored, including on-premise systems, cloud systems, virtual machines, and the like.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

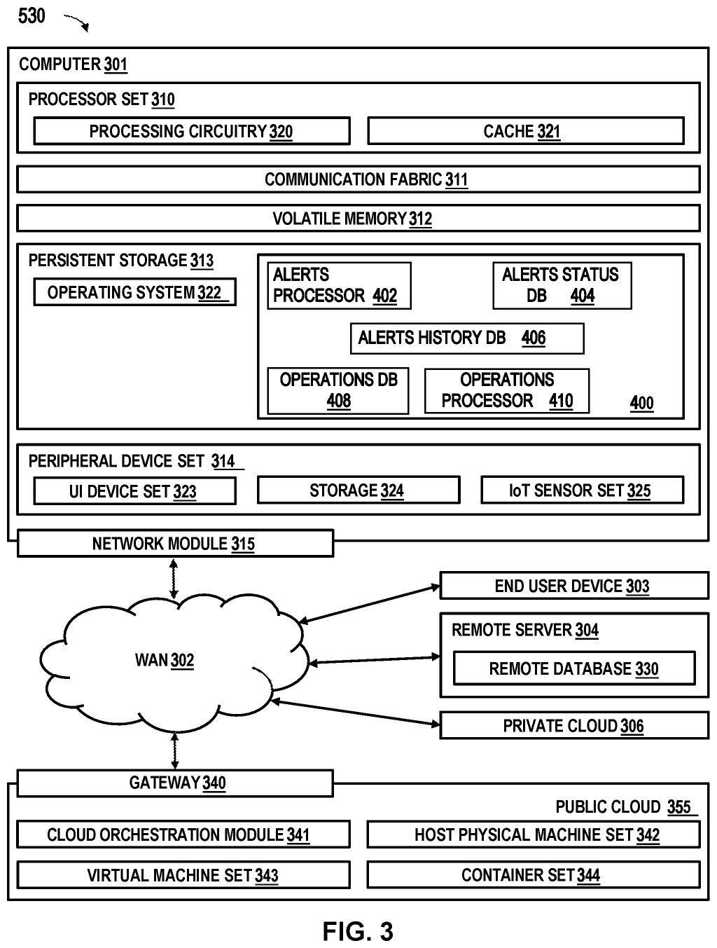

Referring to FIG. 3, computing environment 300 includes an example of an environment for the execution of at least some of the computer code involved in performing the inventive methods, including an alert notification system block 400, which can include an alert processor block 402, an alerts status database block 404, an alerts history database block 406, an operations database block 408 and an operations processor block 410. In addition to block 400, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 400, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 400 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 400 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for identifying anomalies in a monitored system caused by a maintenance operation, comprising:
receiving a first quantity indicative of an event associated with execution of the maintenance operation;
receiving a second quantity indicative of an anomaly associated with the monitoring system; and
calculating an alert silencing score based upon the first quantity and the second quantity,
wherein the alert silencing score is associated with a probability that the second quantity is causally related with the first quantity.

2. The computer-implemented method of claim 1, further comprising continuously determining, based upon the alert silencing score, whether the second quantity is causally related to the maintenance operation.

3. The computer-implemented method of claim 1, further comprising outputting, to an alert notification system, an indication of the second quantity, when it is determined that the second quantity is causally related to the maintenance operation.

4. The computer-implemented method of claim 3, further comprising indicating that the second quantity, previously determined as being causally related to the maintenance operation, is no longer causally related to the maintenance operation.

5. The computer-implemented method of claim 1, further comprising indicating that the second quantity, previously determined as being causally related to the maintenance operation, is no longer causally related to the maintenance operation.

6. The computer-implemented method of claim 1, wherein the first quantity includes a start time of the maintenance operation, an end time of the maintenance operation, and operation names for the maintenance operation.

7. The computer-implemented method of claim 1, wherein the second quantity is an alert received from an observability service.

8. The computer-implemented method of claim 7, further comprising storing each alert in an alerts history database.

9. The computer-implemented method of claim 8, further comprising storing a status of each alert in an alerts status database, the stats including a SILENCED status and a NOT_SILENCED status.

10. A computing device comprising:
a processor;
a memory coupled to the processor; and
a computer-usable medium embodying a computer program code, the computer program code comprising instructions that, when executed by the processor, configures the computing device to perform acts comprising:
receiving a first quantity indicative of an event associated with execution of a maintenance operation;
receiving a second quantity indicative of an anomaly associated with a monitoring system; and
calculating an alert silencing score based upon the first quantity and the second quantity,
wherein the alert silencing score is associated with a probability that the second quantity is causally related with the first quantity.

11. The computing device of claim 10, wherein execution of the computer program code by the processor further configures the computing device to continuously determine, based upon the alert silencing score, whether the second quantity is causally related to the maintenance operation.

12. The computing device of claim 10, wherein execution of the computer program code by the processor further configures the computing device to output, to an alert notification system, an indication of the second quantity, when it is determined that the second quantity is causally related to the maintenance operation.

13. The computing device of claim 10, wherein execution of the computer program code by the processor further configures the computing device to indicate to the monitoring system that the second quantity, previously determined as being causally related to the maintenance operation, is no longer causally related to the maintenance operation.

14. The computing device of claim 10, wherein:
the first quantity includes a start time of the maintenance operation, an end time of the maintenance operation, and operation names for the maintenance operation; and
the second quantity is an alert received from an observability service.

15. The computing device of claim 14, wherein execution of the computer program code by the processor further configures the computing device to store each alert in an alerts history database.

16. The computing device of claim 10, wherein execution of the computer program code by the processor further configures the computing device to store a status of each alert in an alerts status database, the status including a SILENCED status and a NOT_SILENCED status.

17. A non-transitory computer readable storage medium tangibly embodying a computer readable program code having computer readable instructions that, when executed, causes a computer device to carry out a method of determining anomalies in a monitored system caused by a maintenance operation, the method comprising:
receiving a first quantity indicative of an event associated with execution of the maintenance operation;
receiving a second quantity indicative of an anomaly associated with the monitoring system; and
calculating an alert silencing score based upon the first quantity and the second quantity,
wherein the alert silencing score is associated with a probability that the second quantity is causally related with the first quantity.

18. The non-transitory computer readable storage medium of claim 17, wherein the method further comprises continuously determining, based upon the alert silencing score, whether the second quantity is causally related to the maintenance operation.

19. The non-transitory computer readable storage medium of claim 17, wherein the method further comprises providing, to an alert notification system, an indication of the second quantity, when it is determined that the second quantity is causally related to the maintenance operation.

20. The non-transitory computer readable storage medium of claim 17, wherein the method further comprises indicating that the second quantity, previously determined as being causally related to the maintenance operation, is no longer causally related to the maintenance operation.
